(19) United States
(12) Patent Application Publication
(10) Pub. No.: US 2011/0171096 A1
(43) Pub. Date: Jul. 14, 2011

(54) High Throughput Synthesis of Carbide Nanostructures from Natural Biological Materials

(75) Inventor: Xiaodong Li, Irmo, SC (US)

(73) Assignee: UNIVERSITY OF SOUTH CAROLINA, Columbia, SC (US)

(21) Appl. No.: 13/005,165

(22) Filed: Jan. 12, 2011

Related U.S. Application Data
(60) Provisional application No. 61/335,752, filed on Jan. 12, 2010.

(51) Int. Cl. C01B 31/36; C01B 31/30; C01B 31/34

(52) U.S. Cl. 423/291; 423/346; 423/439; 423/440

(57) ABSTRACT

Methods of forming one-dimensional carbide nanostructures are provided. In one embodiment, a carbide forming mixture (e.g., including a noncarbon element source, a catalyst, and a solvent) is applied to a porous plant template (e.g., cotton fibers, bamboo fibers, wood fibers, leaf fibers, straw fibers, or mixtures thereof). The porous plant template can then be dried to evaporate the solvent, and heated to a growth temperature of about 1000° C. or more (e.g., about 1050° C. to about 1300° C.) to grow the one-dimensional carbide nanostructures on the porous plant template.

One-dimensional carbide nanostructures formed according to the presently disclosed methods are also provided.

### PRIORITY INFORMATION

The present application claims priority to U.S. Provisional Patent Application Ser. No. 61/335,752 titled “HIGH THROUGHPUT SYNTHESIS OF CARBIDE NANOSTRUCTURES FROM NATURAL BIOLOGICAL MATERIALS” of Li filed on Jan. 12, 2010, the disclosure of which is incorporated by reference herein.

### GOVERNMENT SUPPORT CLAUSE

This invention was made with government support under awards CMMI-0653651 and CMMI 0968843 awarded by the National Science Foundation. Therefore, the government has certain rights in the invention.

### BACKGROUND

Substantially one-dimensional nanostructures (e.g. nanowires, nanorods, and nanobelts having a length much larger than thickness) are a new class of nanomaterials that can be ideal as model systems for investigating the dependence of electronic transport, optical, and mechanical properties on size confinement and dimensionality as well as for various potential applications, including composite materials, electrode materials, field emitters, nanoelectronics, and nanoscale sensors.

Nanowires are a class of newer one-dimensional nanomaterials with a high aspect ratio (length-to-diameter typically greater than 10), which can be made of various compositions of materials in addition to carbon. Nanowires have demonstrated superior electrical, optical, mechanical and thermal properties. The broad choice of various crystalline materials and doping methods makes the properties (e.g. electrical) of nanowires tunable with a high degree of freedom and precision.

Nanowires can include of a variety of inorganic materials including elemental semiconductors (Si, Ge, and B), Group III-V semiconductors (GaN, GaAs, GaP, InP, InAs), Group II-VI semiconductors (ZnS, ZnSe, CdS, CdSe), and metal oxides (ZnO, MgO, SiO₂, Al₂O₃, SnO₂, WO₃, TiO₂).

Synthesis methods for such 1-D nanostructures usually fall into two categories: vapor-phase deposition or solution-based crystal growth. In most synthesis methods, specially engineered templates are required for production of the 1-D nanostructures. However, these templates add additional manufacturing difficulty and cost to the nanostructures.

As such, a need exists for natural biological materials as templates to synthesize inorganic nanomaterials due to their abundance, hierarchical structure, renewable sources, and environmentally benign characteristic.

### SUMMARY

Objects and advantages of the invention will be set forth in part in the following description, or may be obvious from the description, or may be learned through practice of the invention.

Methods of forming one-dimensional carbide nanostructures are generally provided. In one embodiment, a carbide forming mixture (e.g., including a noncarbon element source, a catalyst, and a solvent) is applied to a porous plant template (e.g., cotton fibers, bamboo fibers, wood fibers, leaf fibers, straw fibers, or mixtures thereof). The porous plant template can then be dried to evaporate the solvent, and heated to a growth temperature of about 1000° C. or more (e.g., about 1050° C. to about 1300° C.) to grow the one-dimensional carbide nanostructures on the porous plant template.

The carbide forming mixture can be formed by mixing the noncarbon element source and the catalyst in the solvent, and optionally oscillating the carbide forming mixture to form an emulsion.

In one particular embodiment, the carbide forming mixture can be applied to the porous plant template such that upon drying the noncarbon element source and the catalyst is applied in an add-on amount of about 0.1 wt. % to about 300 wt. % based on the dried weight of porous plant template.

The porous plant template can be heated to the growth temperature in an inert atmosphere or a vacuum.

The noncarbon element source can be an alkali metal, an alkali earth metal, a transition metal, another metal, or a metalloid (e.g., boron or silicon). In particular embodiments, for example, the noncarbon element source can include, but is not limited to, boron, silicon, titanium, tantalum, molybdenum, tungsten, niobium, vanadium, or zirconium.

The catalyst can include nickel, iron, NaCl, or a mixture thereof (e.g., Ni(NO₃)₂.6H₂O, Fe(NO₃)₃.9H₂O, or mixtures thereof).

The one-dimensional carbide nanostructure can define a length of about 500 nm or more (e.g., about 1 μm to about 10 μm) and an average diameter of about 25 nm to about 250 nm (e.g., about 30 nm to about 100 nm). Additionally, the one-dimensional carbide nanostructure can have an aspect ratio of about 10 or more (e.g., about 15 to about 150).

In one particular embodiment, the one-dimensional carbide nanostructure can be formed without a carbon source present, other than the porous plant template.

One-dimensional carbide nanostructures formed according to the presently disclosed methods are also provided.

Other features and aspects of the present invention are discussed in greater detail below.

### DETAILED DESCRIPTION

Reference now will be made to the embodiments of the invention, one or more examples of which are set forth below. Each example is provided by way of an explanation of the invention, not as a limitation of the invention. In fact, it will be apparent to those skilled in the art that various modifications and variations can be made in the invention without departing from the scope or spirit of the invention. For instance, features illustrated or described as one embodiment can be used on another embodiment to yield still a further embodiment. Thus, it is intended that the present invention cover such modifications and variations as come within the scope of the appended claims and their equivalents. It is to be understood by one of ordinary skill in the art that the present discussion is a description of exemplary embodiments only, and is not intended as limiting the broader aspects of the present invention, which broader aspects are embodied exemplary constructions.

Chemical elements are discussed in the present disclosure using their common chemical abbreviation, such as commonly found on a periodic table of elements. For example, hydrogen is represented by its common chemical abbreviation H; helium is represented by its common chemical abbreviation He; and so forth.

As used herein, the prefix “nano” refers to the nanometer scale (e.g., from about 1 nm to about 999 nm). For example, wires having an average diameter on the nanometer scale (e.g., from about 1 nm to about 999 nm) are referred to as “nanowires”. Wires having an average diameter of greater than 1,000 nm (i.e., 1 μm) are generally referred to as “microwires”, since the micrometer scale generally involves those materials having an average size of greater than 1 μm.

Generally speaking, the present disclosure is directed to scalable synthetic methods for the production of one-dimensional (“1D”) carbide nanostructures using natural organic templates as both the template and the carbon source. As such, the 1D carbide nanostructures can be, in one particular embodiment, formed without a carbon source present, other than the porous plant template. The present disclosure is also directed to the 1D carbide nanostructures (e.g., nanowires) produced according to these methods. These 1D nanostructures potentially hold promise as building blocks for nanocomposites and nanodevices. Although the present disclosure refers to these structures as 1-dimensional, they are actually 3-dimensional wire-like, rod-like, or tube-like structures, having a 1-dimensional appearance on the nano-scale.

For example, in some embodiments, the 1D nanostructures can have a length of about 500 nm (0.5 μm) or more, such as from about 1 micrometer (μm) to about 10 μm. In some embodiments, the nanofibers can have a length of about 2 μm or more, such as about 3 μm to about 5 μm. In some embodiments, the 1D nanostructures can be longer than about 5 μm, such as about 5 μm to about 10 μm. The average diameter of the nanofibers can be about 25 nanometers (nm) to about 250 nm, such as about 30 nm to about 150 nm.

In particular embodiments, the 1D nanostructures can have an aspect ratio (i.e., determined by the length of the 1D nanostructure divided by the average diameter of the 1D nanostructure) that is about 10 or more, such as about 15 to about 150. In particular embodiments, the aspect ratio of the 1D nanostructures can be about 25 to about 100.

The 1D nanostructures can be composed of carbide materials. In one particular embodiment, the 1D nanostructures consist essentially of carbide materials (e.g., having no other structurally significant materials, but may include dopants and/or other impurities in a trace amount such as less than 0.5% by weight). For instance, the 1D nanostructures consist of carbide materials in certain embodiments.

As used herein, the term “carbide” refers to a compound composed of carbon (C) and one (or more) more electropositive element (i.e., the noncarbon element), excluding carbon-hydrogen compounds. For example, the noncarbon element of the carbide can be an alkali metal, alkali earth metal, transition metal, other metal, or metalloid. Particularly suitable carbides include, but are not limited to, boron carbide (B₄C), silicon carbide (SiC), titanium carbide (TiC), tantalum carbide (TaC), molybdenum carbide (Mo₂C), tungsten carbide (WC), tungsten semicarbide (W₂C), niobium carbide (NbC), vanadium carbide (VC), zirconium carbide (ZrC), or mixtures thereof.

The 1D nanostructures of the present invention are generally produced using natural organic templates as both the template and the carbon source for formation of the carbides. In one particular embodiment, the natural organic template can be a porous plant template that defines a plurality of pores (e.g., a me-soporous plant template defining pores having a pore diameter of about 2 nm to about 50 nm). Suitable porous plant templates can be cotton, bamboo, wood, leaf, straw fibers, etc., or mixtures thereof. Cotton as the porous template is particularly suitable, since it is a remarkable pure fiber, with a cellulose content of greater than 95 wt % in the dry fiber when harvested. Additionally, cotton has the ability to absorb large quantities of liquids, which can be helpful in the presently described method.

The 1D nanostructures can be formed by first mixing the noncarbon element source and a catalyst(s) in a suitable solvent to form a carbide forming mixture. The carbide forming mixture can be, in one embodiment, oscillation (e.g., ultrasound oscillation, mechanical oscillation, etc.) to form an emulsion or other mixture.

The carbide mixture can be applied onto the porous plant template (e.g., via dipping, spraying, coating, or other application techniques), dried, and cured. The drying conditions can be sufficient to remove the solvent from the template, such as at temperatures above the boiling temperature of the solvent(s). For example, the drying temperature can be about 50° C. to about 100° C., such as about 65° C. to about 95° C. for a drying period sufficient to evaporate substantially all of the solvent from the template. Curing conditions can be at curing temperatures above the drying temperature (e.g., about 90° C. or greater, such as about 90° C. to about 250° C.).

The noncarbon element source and the catalyst can be applied in an add-on amount of about 0.1 weight percent (wt. %) to about 300 wt. %, based on the dried weight of porous plant template, such as about 1 wt. % to about 200 wt. %.

The 1D carbide nanostructures can then be synthesized by heating to a growth temperature of about 1000° C. or more (e.g., about 1050° C. to about 1300° C.) under inert atmosphere conditions (e.g., in an inert atmosphere, such as containing argon) or vacuum (e.g., pressures less than 100 mTorr). The growth period can be varied to control the length of the synthesized 1D carbide nanostructures, which can generally be a direct relationship (i.e., the greater the period of growth can result in longer nanostructures).

The catalyst(s) can vary depending on the particular noncarbon element source used to make the carbide 1D nanostructures. For example, when the noncarbon element source supplies boron or silicon, the catalyst system can include nickel (e.g., Ni(NO₃)₂.6H₂O), iron (e.g., Fe(NO₃)₃.9H₂O), NaCl, or a mixture thereof.

The solvent can be any suitable system, such as including an alcohol (e.g., methanol, ethanol, propanol, etc.), water, etc., and mixtures thereof.

This synthetic method is highlighted by its simplicity and high yield production.

### EXAMPLES

A series of intriguing 1D carbide nanostructures of B₄C, SiC and TiC were successfully prepared.

### Example 1

### Synthesis of B₄C Nanorods

The catalyst and boron source were loaded to the cotton T-shirt via the traditional dipping, drying and curing procedure. To start with, 5 g of Ni(NO₃)₂.6H₂O, 5 g of Fe(NO₃)₃.9H₂O and 10 g of amorphous boron powders were dissolved into 80 ml of ethanol to form a Fe—Ni—B emulsion under ultrasound irradiation. Then, a piece of T-shirt weight 15 g was cut and dipped in the Fe—Ni—B emulsion. After stirring for 2 h, the cotton textile was dried at 70° C. for 5 min in a preheated oven and finally cured at 105° C. for 3 h. The boron carbide nanorods were synthesized in a horizontal alumina tube furnace. The nickel, iron and boron loaded cotton textile was inserted into the center of the tube furnace and heated at 1160° C. for 4 h with 600 sccm (standard cubic centimeter) continuous flow of argon.

SEM images revealed tremendous amounts of B₄C nanorods grew radially with a uniform coverage. The diameter of the nanorods ranged from 30 to 150 nm, and the length was over 3 μm. High magnification scanning electron microscopy (SEM) imaging showed that there was a spherical catalyst particle on the tip of each nanowire, indicating the top growth mechanism. Electron energy loss spectrum (EELS) analysis of the B₄C nanorods revealed two distinct absorption features, one starting at 188 eV and the other at 284 eV, corresponding to the known B-k and C-k edges, respectively. High resolution transmission electron microscopy (HRTEM) imaging of a B₄C nanorods along the [010] zone axis and the fast Fourier transform (FFT) diffraction pattern revealed that the B₄C grow along the [001] zone axis.

As such, the B₄C nanorods exhibited superior mechanical properties. In situ back and forth buckling tests demonstrated the ultrahigh flexibility and strong mechanical toughness of the prepared B₄C nanorods. After more than 30 times of high strain deformation bending, no brittle failure or obvious residual deformation could be found.

### Example 2

### Synthesis of SiC Nanorods

0.7144 g of Ni(NO₃)₂.6H₂O and 0.3437 g silicon nanopowders as the raw materials were dissolved into 60 ml ethanol to form a Ni—Si emulsion. A piece of cotton T-shirt, weight 0.1510 g, was dipped into the Ni—Si emulsion after subjecting the emulsion to 10 min ultrasound irradiation. Then, the emulsion was stirred for 1 h, and the template was removed. The cotton textile was dried at 70° C. for 30 min in a preheated oven and then cured at 90° C. for 2 h. The SiC nanorods were synthesized in a horizontal alumina tube furnace by inserting the Ni and Si loaded cotton textile into the center of the tube furnace and heating at 1200° C. for 2 h with 300 sccm (standard cubic centimeter) continuous flow of argon.

The SiC nanorods formed had a length over 3 μm and a diameter of about 20 nm to about 200 nm.

### Example 3

### Synthesis of TiC Nanorods

To start with, 1.7970 g Ni(NO₃)₂.6H₂O, 0.3610 g NaCl and 1.6603 g amorphous titanium powders were dissolved into 70 ml ethanol to form a Ni—Ti—Cl emulsion under ultrasound irradiation. Then, a piece of T-shirt weight 0.3706 g was cut and dipped in the Ni—Ti—Cl emulsion. After stirring for 2 h, the cotton textile was dried at 85° C. for 30 min in a preheated oven and finally cured at 100° C. for 1 h. The TiC nanorods were synthesized in a horizontal alumina tube furnace. The nickel, chlorine and titanium loaded cotton textile was inserted into the center of the tube furnace and heated at 1300° C. for 1 h with 500 sccm (standard cubic centimeter) continuous flow of argon.

The TiC nanorods formed had a length over 500 nm and a diameter of about 50 nm to about 250 nm.

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged both in whole or in part. Furthermore, those of ordinary skill in the art will appreciate that the foregoing description is by way of example only, and is not intended to limit the invention so further described in the appended claims.

What is claimed:

1. A method of forming one-dimensional carbide nanostructures, the method comprising:
applying a carbide forming mixture to a porous plant template, wherein the carbide forming mixture comprises a noncarbon element source, a catalyst, and a solvent;
drying the porous plant template to evaporate the solvent; and
heating the porous plant template to a growth temperature of about 1000° C. or more to grow the one-dimensional carbide nanostructures on the porous plant template.

2. The method as in claim 1, further comprising:
forming the carbide forming mixture by mixing the noncarbon element source and the catalyst in the solvent.

3. The method as in claim 2, further comprising:
oscillating the carbide forming mixture to form an emulsion.

4. The method as in claim 1, wherein the porous plant template comprises cotton fibers, bamboo fibers, wood fibers, leaf fibers, straw fibers, or mixtures thereof.

5. The method as in claim 1, wherein the porous plant template comprises cotton fibers.

6. The method as in claim 1, wherein the carbide forming mixture is applied to the porous plant template such that upon drying the noncarbon element source and the catalyst is applied in an add-on amount of about 0.1 wt. % to about 300 wt. %, based on the dried weight of porous plant template.

7. The method as in claim 1, wherein the growth temperature is about 1050° C. to about 1300° C.

8. The method as in claim 1, wherein the porous plant template is heated to the growth temperature in an inert atmosphere.

9. The method as in claim 1, wherein the noncarbon element source comprises an alkali metal, an alkali earth metal, a transition metal, another metal, or a metalloid.

10. The method as in claim 1, wherein the noncarbon element source comprises a metalloid.

11. The method as in claim 10, wherein the metalloid comprises boron or silicon.

12. The method as in claim 1, wherein the noncarbon element source comprises boron, silicon, titanium, tantalum, molybdenum, tungsten, niobium, vanadium, or zirconium.

13. The method as in claim 1, wherein the catalyst comprises nickel, iron, NaCl, or a mixture thereof.

14. The method as in claim 1, wherein the noncarbon element source comprises boron and the catalyst comprises nickel and iron, and wherein the carbide nanostructure comprises B₄C.

15. The method as in claim 14, wherein the catalyst comprises Ni(NO₃)₂.6H₂O and Fe(NO₃)₃.9H₂O.

16. The method as in claim 1, wherein the noncarbon element source comprises silicon and the catalyst comprises nickel and iron, and wherein the carbide nanostructure comprises SiC.

17. The method as in claim 16, wherein the catalyst comprises Ni(NO₃)₂.6H₂O and Fe(NO₃)₃.9H₂O.

18. The method as in claim 1, wherein the one-dimensional carbide nanostructure defines a length of about 500 nm or more and an average diameter of about 25 nm to about 250 nm.

19. The method as in claim 18, wherein the one-dimensional carbide nanostructure defines a length of about 1 μm to about 10 μm and an average diameter of about 30 nm to about 150 nm.

20. The method as in claim 18, wherein the one-dimensional carbide nanostructure has an aspect ratio of about 10 or more.

21. The method as in claim 18, wherein the one-dimensional carbide nanostructure has an aspect ratio of about 15 to about 150.

22. The method as in claim 1, wherein the one-dimensional carbide nanostructure is formed without a carbon source present, other than the porous plant template.

23. A one-dimensional carbide nanostructure formed according to the method of claim 1.
